(19) United States
(12) Patent Application Publication
(10) Pub. No.: US 2026/0095526 A1
(43) Pub. Date: Apr. 2, 2026

(54) TECHNIQUES FOR SELECTING PAIRING STRATEGIES IN A TASK ASSIGNMENT SYSTEM

(71) Applicant: Afiniti AI Limited, Dublin (IE)

(72) Inventors: Kevin ALLAND, Rockville, MD (US); Altan ERDOGAN, Istanbul (TR)

(73) Assignee: Afiniti AI Limited, Dublin (IE)

(21) Appl. No.: 19/414,364

(22) Filed: Dec. 10, 2025

Related U.S. Application Data
(63) Continuation of application No. PCT/US2024/033863, filed on Jun. 13, 2024.
(60) Provisional application No. 63/472,786, filed on Jun. 13, 2023.

(51) Int. Cl. H04M 3/523

(52) U.S. Cl. CPC H04M 3/5232

(57) ABSTRACT

There is provided a method. The method comprises obtaining historical agent connection data that includes information about agents that were paired with contacts having a plurality of contact types (CTs) and, based on the historical agent connection data, determining similarity scores each of which indicates a similarity between two CTs with respect to agents that were paired with contacts of the two CTs. The method further comprises, based on the determined similarity scores, grouping the plurality of CTs into a plurality of CT clusters, wherein each CT cluster includes one or more CTs, and for each of the plurality of CT clusters, selecting a pairing strategy (PS) from a plurality of PSs.

### CROSS-REFERENCE TO RELATED APPLICATIONS

This application is a continuation of International Patent Application No. PCT/US2024/033863, filed on 2024 Jun. 13, which claims the benefit of U.S. provisional patent application No. 63/472,786, filed on 2023 Jun. 13. The above identified applications are incorporated by this reference.

### TECHNICAL FIELD

This disclosure generally relates to techniques for selecting pairing strategies (PSs) in a task assignment system.

### BACKGROUND

A typical task assignment system algorithmically assigns a finite number of tasks to a finite number of workers (“agents”) over a time period. One example of the task assignment system is a contact center (e.g., a call center). In a call center, a finite number of callers call into the call center, and a finite number of agents are available for handling the calls. Each caller, with various needs and reasons for calling, represents a task to be assigned to one of the call center agents.

A task may be assigned to one of the call center agents according to a task assignment strategy (a.k.a., a “pairing strategy” (“PS”)). A PS determines which tasks are assigned to which agents. There are various types of a PS.

One type of a PS is a first-in/first-out (“FIFO”) strategy. In the FIFO strategy, for example, the longest-waiting agent receives the next available task (in case the number of available agents is greater than the number of available tasks) or the longest-waiting task is assigned to the next available agent (in case the number of available tasks is greater than the number of available agents). Another type of a PS is a performance-based routing (PBR) strategy. In the PBR strategy, for example, the highest-performing agent among available agents receives the next available task.

### SUMMARY

A typical task assignment system may pair various tasks with agents using a single PS. But there may be a scenario where it is not desirable to use a single PS to pair various tasks with agents. In other words, there may be a scenario where it is desirable to use more than one PS to pair various tasks with agents.

For example, let's assume that there are three types of callers waiting at a task assignment system to speak to agents. A first type of the callers is a first group of callers who just want to check the status of their online orders. A second type of the callers is a second group of callers who want to cancel their online orders. A third type of the callers is a third group of callers who need help on how to use a particular electronic product.

For the first caller group, it may be okay to use the FIFO strategy to pair the callers to the agents because looking up the status of online orders does not require a special skill set, and thus it may be desirable to assign a caller to any agent who becomes available first. Similarly, for the second caller group, it may be okay to use the FIFO strategy to pair the callers to the agents because, like looking up the status of online orders, cancelling online orders does not require a special skill set.

On the other hand, for the third caller group, it may not be desirable to use the FIFO strategy to pair the callers to the agents because not all agents may have the same knowledge of how to use the electronic product. Thus, for the third caller group, it may be desirable to use the PBR strategy or a BP strategy to pair the agents with the most knowledge in how to use the electronic product to the callers first.

Therefore, there is a need to select and apply the same PS or different PSs to different contact types depending on a similarity between the different contact types.

Accordingly, in one aspect of the embodiments of this disclosure, there is provided a method comprising obtaining historical agent connection data that includes information about agents that were paired with contacts having a plurality of contact types (CTs); based on the historical agent connection data, determining similarity scores each of which indicates a similarity between two CTs with respect to agents that were paired with contacts of the two CTs; based on the determined similarity scores, grouping the plurality of CTs into a plurality of CT clusters, wherein each CT cluster includes one or more CTs; and for each of the plurality of CT clusters, selecting a pairing strategy (PS) from a plurality of PSs.

In another aspect, there is provided a computer program comprising instructions which when executed by processing circuitry cause the processing circuitry to perform the method of at least one of the embodiments described above.

In another aspect, there is provided a carrier containing the computer program of embodiment B1, wherein the carrier is one of an electronic signal, an optical signal, a radio signal, and a computer readable storage medium.

In another aspect, there is provided an apparatus being configured to obtain historical agent connection data that includes information about agents that were paired with contacts having a plurality of contact types (CTs); based on the historical agent connection data, determine similarity scores each of which indicates a similarity between two CTs with respect to agents that were paired with contacts of the two CTs; based on the determined similarity scores, group the plurality of CTs into a plurality of CT clusters, wherein each CT cluster includes one or more CTs; and for each of the plurality of CT clusters, select a pairing strategy (PS) from a plurality of PSs.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1A illustrates an example communication system according to an embodiment.

FIG. 1B illustrates an example communication system according to an embodiment.

FIG. 1C illustrates an example communication system according to an embodiment.

FIG. 1D illustrates an example communication system according to an embodiment.

FIG. 2 shows a graph showing a plurality of contact type clusters.

FIG. 3 shows an exemplary graphical user interface according to some embodiments.

FIG. 4 shows a process according to some embodiments.

FIG. 5 shows an apparatus according to some embodiments.

FIG. 6 shows a system according to some embodiments.

### DETAILED DESCRIPTION

A typical contact center algorithmically assigns contacts arriving at the contact center to agents available to handle those contacts. At times, the contact center may have agents available and waiting for assignment to inbound or outbound contacts (e.g., telephone calls, Internet chat sessions, email) or outbound contacts. At other times, the contact center may have contacts waiting in one or more queues for an agent to become available for assignment.

In some typical contact centers, contacts are assigned to agents ordered based on time of arrival, and agents receive contacts ordered based on the time when those agents became available. This strategy may be referred to as a “first-in, first-out”, “FIFO”, or “round-robin” strategy. For example, a longest-available agent pairing strategy preferably selects the available agent who has been available for the longest time.

Some contact centers may use a “performance based routing” or “PBR” approach to ordering the queue of available agents or, occasionally, contacts. PBR ordering strategies attempt to maximize the expected outcome of each contact-agent interaction but do so typically without regard for utilizing agents in a contact center uniformly. Some variants of PBR may include a highest-performing-agent pairing strategy, preferably selecting the available agent with the highest performance, or a highest-performing-agent-for-contact-type pairing strategy, preferably selecting the available agent with the highest performance for the type of contact being paired.

For yet another example, some contact centers may use a “behavioral pairing” or “BP” strategy, under which contacts and agents may be deliberately (preferentially) paired in a fashion that enables the assignment of subsequent contact-agent pairs such that when the benefits of all the assignments under a BP strategy are totaled they may exceed those of FIFO and PBR strategies. BP is designed to encourage balanced utilization of agents within a skill queue while nevertheless simultaneously improving overall contact center performance beyond what FIFO or PBR methods will allow. This is a remarkable achievement inasmuch as BP acts on the same calls and same agents as FIFO or PBR methods, utilizes agents approximately evenly as FIFO provides, and yet improves overall contact center performance. BP is described in, e.g., U.S. patent application Ser. No. 14/871,658, filed Sep. 30, 2015, which is incorporated by reference herein. Additional information about these and other features regarding the pairing or matching modules (sometimes also referred to as “SATMAP”, “routing system”, “routing engine”, etc.) is described in, for example, U.S. Pat. No. 8,879,715, which is incorporated herein by reference.

Some contact centers may use a variety of other possible pairing strategies. For example, in a longest-available agent pairing strategy, an agent may be selected who has been waiting (idle) the longest time since the agent's most recent contact interaction (e.g., call) has ended. In a least-occupied agent pairing strategy, an agent may be selected who has the lowest ratio of contact interaction time to waiting or idle time (e.g., time spent on calls versus time spent off calls). In a fewest-contact-interactions-taken-by-agent pairing strategy, an agent may be selected who has the fewest total contact interactions or calls. In a randomly-selected-agent pairing strategy, an available agent may be selected at random (e.g., using a pseudorandom number generator). In a sequentially-labeled-agent pairing strategy, agents may be labeled sequentially, and the available agent with the next label in sequence may be selected.

In situations where multiple contacts are waiting in a queue, and an agent becomes available for connection to one of the contacts in the queue, a variety of pairing strategies may be used. For example, in a FIFO or longest-waiting-contact pairing strategy, the agent may be preferably paired with the contact that has been waiting in queue the longest (e.g., the contact at the head of the queue). In a randomly-selected-contact pairing strategy, the agent may be paired with a contact selected at random from among all or a subset of the contacts in the queue. In a priority-based routing or highest-priority-contact pairing strategy, the agent may be paired with a higher-priority contact even if a lower-priority contact has been waiting in the queue longer.

In some embodiments, a contact center may switch (or “cycle”) periodically among at least two different pairing strategies (e.g., between FIFO and PBR; between PBR and BP; among FIFO, PBR, and BP). Additionally, the outcome of each contact-agent interaction may be recorded along with an identification of which pairing strategy (e.g., FIFO, PBR, or BP) had been used to assign that particular contact-agent pair. By tracking which interactions produced which results, the contact center may measure the performance attributable to a first strategy (e.g., FIFO) and the performance attributable to a second strategy (e.g., PBR). In this way, the relative performance of one strategy may be benchmarked against the other. The contact center may, over many periods of switching between different pairing strategies, more reliably attribute performance gain to one strategy or the other.

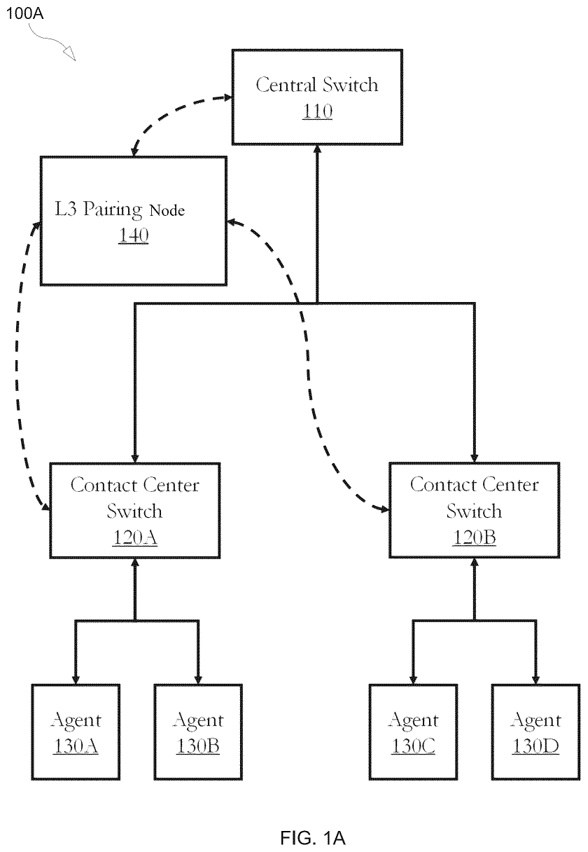

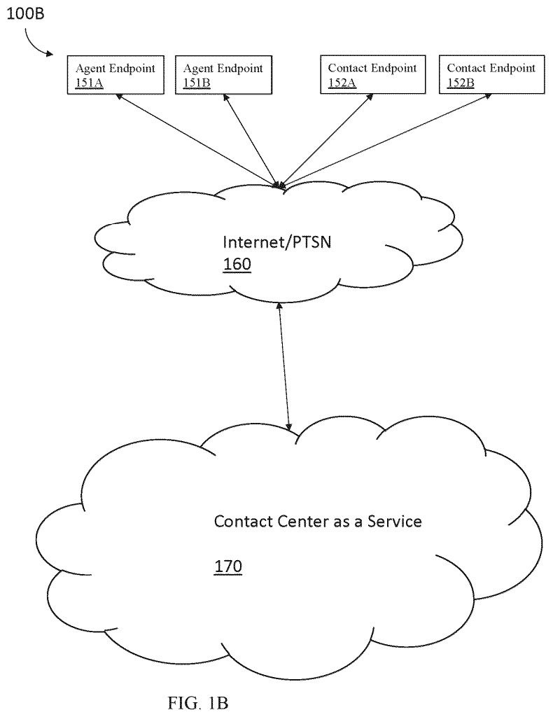

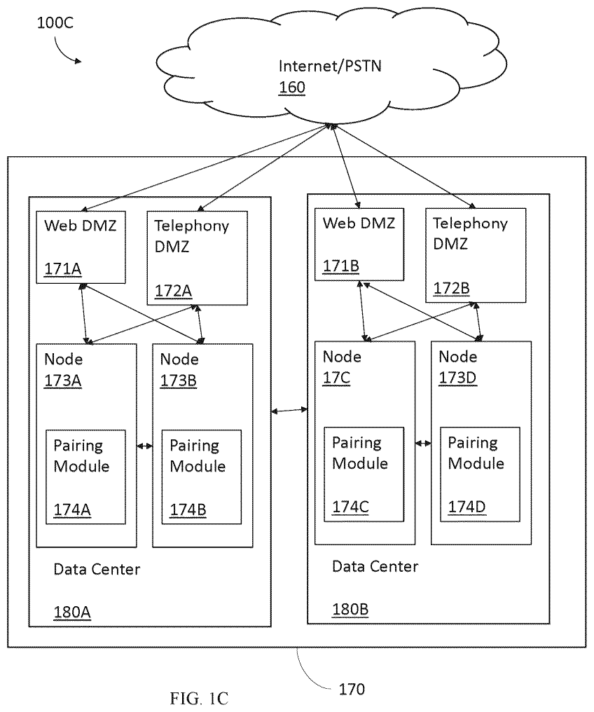

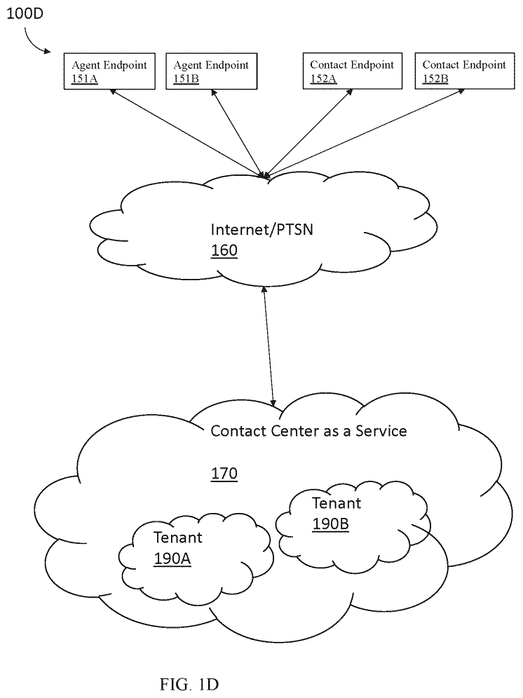

FIG. 1A illustrates an example communication system 100A. In this example, communication system 100A is a contact center system. As shown in FIG. 1A, the communication system 100A may include a central switch 110. The central switch 110 may receive incoming contacts (e.g., callers) or support outbound connections to contacts via a telecommunications network (not shown). The central switch 110 may include contact routing hardware and software for helping to route contacts among one or more contact centers, or to one or more Private Branch Exchanges (PBXs) and/or Automatic Call Distributers (ACDs) or other queuing or switching components, including other Internet-based, cloud-based, or otherwise networked contact-agent hardware or software-based contact center solutions.

The central switch 110 may not be necessary such as if there is only one contact center, or if there is only one PBX/ACD routing component, in the communication system 100A. If more than one contact center is part of the communication system 100A, each contact center may include at least one contact center switch (e.g., contact center switches 120A and 120B). The contact center switches 120A and 120B may be communicatively coupled to the central switch 110. In embodiments, various topologies of routing and network components may be configured to implement the contact center system.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-call functions such as logging information about the call, or taking a break.

In the example of FIG. 1A, the central switch 110 routes contacts to one of two contact centers via contact center switch 120A and contact center switch 120B, respectively. Each of the contact center switches 120A and 120B are shown with two agents each. Agents 130A and 130B may be logged into contact center switch 120A, and agents 130C and 130D may be logged into contact center switch 120B.

The communication system 100A may also be communicatively coupled to an integrated service from, for example, a third party vendor. In the example of FIG. 1A, a pairing node 140 may be communicatively coupled to one or more switches in the switch system of the communication system 100A, such as central switch 110, contact center switch 120A, or contact center switch 120B. In some embodiments, switches of the communication system 100A may be communicatively coupled to multiple pairing nodes. In some embodiments, pairing node 140 may be embedded within a component of a contact center system (e.g., embedded in or otherwise integrated with a switch). The pairing node 140 may receive information from a switch (e.g., contact center switch 120A) about agents logged into the switch (e.g., agents 130A and 130B) and about incoming contacts via another switch (e.g., central switch 110) or, in some embodiments, from a network (e.g., the Internet or a telecommunications network) (not shown).

A contact center may include multiple pairing nodes. In some embodiments, one or more pairing nodes may be components of pairing node 140 or one or more switches such as central switch 110 or contact center switches 120A and 120B. In some embodiments, a pairing node may determine which pairing node may handle pairing for a particular contact. For example, the pairing node may alternate between enabling pairing via a Behavioral Pairing (BP) strategy and enabling pairing with a First-in-First-out (FIFO) strategy. In other embodiments, one pairing node (e.g., the BP pairing node) may be configured to emulate other pairing strategies.

FIG. 1B illustrates a second example communication system 100B. As shown in FIG. 1B, the communication system 100B may include one or more agent endpoints 151A, 151B and one or more contact endpoints 152A, 152B. The agent endpoints 151A, 151B may include an agent terminal and/or an agent computing device (e.g., laptop, cellphone). The contact endpoints 151A, 151B may include a contact terminal and/or a contact computing device (e.g., laptop, cellphone). Agent endpoints 151A, 151B and/or contact endpoints 152A, 152B may connect to a Contact Center as a Service (CCaaS) 170 through either the Internet or a public switched telephone network (PSTN), according to the capabilities of the endpoint device.

FIG. 1C illustrates an example communication system 100C with an example configuration of a CCaaS 170. For example, a CCaaS 170 may include multiple data centers 180A, 180B. The data centers 180A, 180B may be separated physically, even in different countries and/or continents. The data centers 180A, 180B may communicate with each other. For example, one data center is a backup for the other data center; so that, in some embodiments, only one data center 180A or 180B receives agent endpoints 151A, 151B and contact endpoints 152A, 152B at a time.

Each data center 180A, 180B includes web demilitarized zone equipment 171A and 171B, respectively, which is configured to receive the agent endpoints 151A, 151B and contact endpoints 152A, 152B, which are communicatively connecting to CCaaS via the Internet. Web demilitarized zone (DMZ) equipment 171A and 171B may operate outside a firewall to connect with the agent endpoints 151A, 151B and contact endpoints 152A, 152B while the rest of the components of data centers 180A, 180B may be within said firewall (besides the telephony DMZ equipment 172A, 172B, which may also be outside said firewall). Similarly, each data center 180A, 180B includes telephony DMZ equipment 172A and 172B, respectively, which is configured to receive agent endpoints 151A, 151B and contact endpoints 152A, 152B, which are communicatively connecting to CCaaS via the PSTN. Telephony DMZ equipment 172A and 172B may operate outside a firewall to connect with the agent endpoints 151A, 151B and contact endpoints 152A, 152B while the rest of the components of data centers 180A, 180B (excluding web DMZ equipment 171A, 171B) may be within said firewall.

Further, each data center 180A, 180B may include one or more nodes 173A, 173B, and 173C, 173D, respectively. All nodes 173A, 173B and 173C, 173D may communicate with web DMZ equipment 171A and 171B, respectively, and with telephony DMZ equipment 172A and 172B, respectively. In some embodiments, only one node in each data center 180A, 180B may be communicating with web DMZ equipment 171A, 171B and with telephony DMZ equipment 172A, 172B at a time.

Each node 173A, 173B, 173C, 173D may have one or more pairing modules 174A, 174B, 174C, 174D, respectively. Similar to pairing module 140 of communications system 100A of FIG. 1A, pairing modules 174A, 174B, 174C, 174D may pair contacts to agents. For example, the pairing module may alternate between enabling pairing via a Behavioral Pairing (BP) module and enabling pairing with a First-in-First-out (FIFO) module. In other embodiments, one pairing module (e.g., the BP module) may be configured to emulate other pairing strategies.

Turning now to FIG. 1D, the disclosed CCaaS communication systems (e.g., FIGS. 1B and/or 1C) may support multi-tenancy such that multiple contact centers (or contact center operations or businesses) may be operated on a shared environment. That is, each tenant may have a separate, non-overlapping pool of agents. CCaaS 170 is shown in FIG. 1D as comprising two tenants 190A and 190B. Turning back to FIG. 1C, for example, multi-tenancy may be supported by node 173A supporting tenant 190A while node 173B supports 190B. In another embodiment, data center 180A supports tenant 190A while data center 180B supports tenant 190B. In another example, multi-tenancy may be supported through a shared machine or shared virtual machine; such at node 173A may support both tenants 190A and 190B, and similarly for nodes 173B, 173C, and 173D. In other embodiments, the system may be configured for a single tenant within a dedicated environment such as a private machine or private virtual machine.

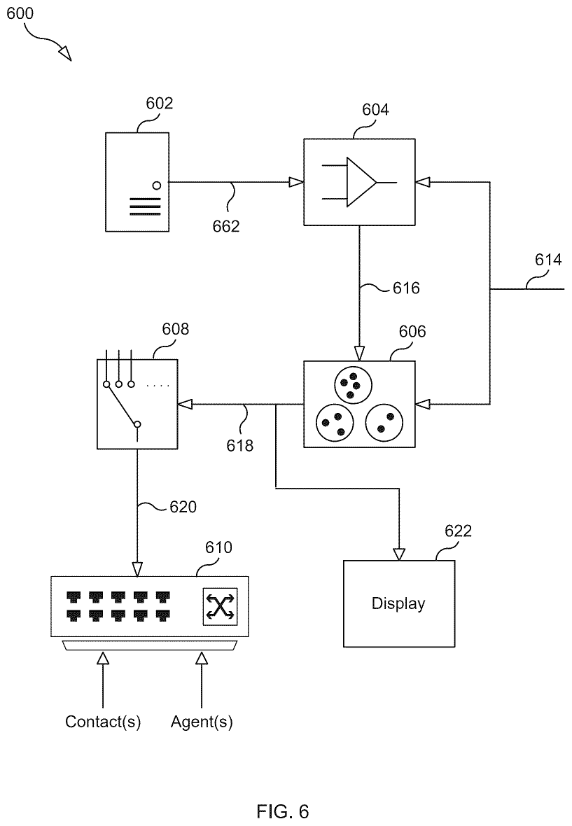

FIG. 6 shows a system 600 according to some embodiments. The system 600 may be configured to group a plurality of task groups into one or more task group clusters, and select, for each task group cluster, a pairing strategy (PS) used for pairing one or more tasks with one or more agents who can handle the tasks. Examples of the PS include FIFO, two-dimensional (2D) BP, 3D BP, etc.

In some embodiments, since a task (e.g., placing an order, requesting for a refund, checking the status of an online order) is requested by a customer contacting a task assignment system via an email, a call, or any other communication means, each task may correspond to a contact. For easy understanding, in the rest of this disclosure, the word “contact” may be used instead of the word “task.”

As shown in FIG. 6, the system 600 may comprise a data collector 602, a similarity score calculator 604, a clustering module 606, a pairing strategy (PS) selector 608, a switch 610, and a display 622.

The data collector 602 may be configured to obtain historical information about previous pairings of contacts and agents. The historical information may be related to one or more of: a routing treatment, a log-in event, a log-out event, agent attributes, agent skills, and/or agent eligibility. More specifically, in some embodiments, the historical information for each previous pairing of a contact and an agent may include one or more parameters or values related to one or more of the followings: (1) how the agent was assigned to a queue for waiting to be paired with a contact, (2) a priority level of the queue, (3) a priority level of the agent, (4) a priority level of the contact, (5) whether an interactive voice response (IVR) was used, (6) whether a least-occupied routing was used, (7) whether a location-based routing was used, (8) whether a routing based on prior touches was used, (9) a log-in time of the agent (e.g., the timing of when the agent became available), (10) a log-out time of the agent (e.g., the timing of when the agent became unavailable), (11) an arrival time of the contact (e.g., the timing of when the contact was connected to the task assignment system), (12) a disconnect time of the contact (e.g., the timing of when the contact was disconnected from the task assignment system), (13) information about the agent's skill(s), (14) information about the agent's eligibility, (15) information about the agent's attribute(s) and/or (16) information about the contact, such as skill required, contact eligibility, contact attribute(s), and/or a contact type.

After obtaining the historical information, the data collector 602 may send the obtained historical information 612 to the similarity score calculator 604. Alternatively, the data collector 602 may derive certain information from the obtained historical information and send the derived information 612 to the similarity score calculator 604.

The similarity score calculator 604 may be configured to receive the information 612 and contact type (CT) identifiers 614 (e.g., CT #1, CT #2, CT #3, CT #4, CT #5). The CT identifiers may be received with the obtained historical information 612 or may be received otherwise from a model associated with the contact center operation during the time that the historical information 612 was collected. In some examples, the CT identifiers 614 is a model or pairing strategy applied to a contact. Each CT identifier identifies a CT, and each CT may be determined based on a combination of various parameters related to a contact and/or agent(s) paired or available for pairing with the contact.

In some embodiments, a contact may be included in a contact group. For example, a contact group or contact type may be a partition or grouping of contacts based on historical contact-agent interaction data. As one example, contacts who arrive at a contact center may be assigned to or associated with a specific contact group or type. In some embodiments, a contact group may be defined as a contact percentile range. For example, percentiles may comprise a division of a ranked data set into a set number of (e.g., 100) equal parts. In one example, each (ranked) data set has 99 percentiles that divide it into 100 equal parts. For example, the kth percentile is denoted by Pk, where k is an integer in the range 1 to 99. In some embodiments, the contact percentile range may include a group of percentiles and/or these groups may be ranked. For example, a percentile rank of a score refers to the percentage of metrics in its frequency distribution that are lower than it or equal to. For example, a metric that is greater than 75% of the metrics of results of contacts in contact-agent interactions may be at the 75th percentile. For example, having a sufficient number of contact groups ensures that there is enough diversity in the data to test behavioral pairing strategies in the contact center environment.

Upon receiving the historical information 612 and the CT identifiers 614, the similarity score calculator 604 may be configured to calculate a similarity score between two CTs based on the information 612. In some examples, the similarity score may be based on a measurement of dissimilarity between two CTs based on the information 612.

Each similarity score may indicate a similarity between two CTs with respect to the agents that were previously paired with the contacts of the two CTs. The similarity score between the CT #1 and the CT #2 may be determined based on an actual routing treatment of agents paired with the contacts and/or agent eligibility for pairing with the contacts. In one example, the similarity score between the CT #1 and the CT #2 may indicate a similarity between the agents that were paired with the contacts of the CT #1 and the agents that were paired with the contacts of the CT #2 (e.g., a measure of overlap between the agents paired with the contacts of the CT #1 and the agents paired with the contacts of the CT #2). In another example, the similarity score may indicate a similarity between the agents that were eligible to be paired with the contacts of the CT #1 (i.e., the agents who could have handled the contacts of the CT #1) and the agents that were eligible to be paired with the contacts of the CT #2. Table 1 provided below shows an example of 10 similarity scores for 10 pairs of CTs.

TABLE 1

| Pair of CTs | | Similarity Score |
|---|---|---|
| CT #1 | CT #2 | 8 |
| CT #1 | CT #3 | 3 |
| CT #1 | CT #4 | 1 |
| CT #1 | CT #5 | 1 |
| CT #2 | CT #3 | 4 |
| CT #2 | CT #4 | 7 |
| CT #2 | CT #5 | 3 |
| CT #3 | CT #4 | 2 |
| CT #3 | CT #5 | 8 |
| CT #4 | CT #5 | 1 |

In some embodiments, a similarity between two CTs may be indicated using an adjacency matrix and/or a node/edge graph, and the similarity score may be determined based on the adjacency matrix and/or the node/edge graph.

As explained above, in order to determine the similarity between two CTs, the similarity between the agents paired with one of the CTs and the agents paired with another one of the CT can be determined. In order to find this “agent similarity,” sufficient information about the previous pairings should be obtained. Accordingly, in some embodiments, threshold values may be set for determining whether the information about the previous pairings collected for determining the similarity is sufficient or not. More specifically, in one example, there may be a threshold value for any one of a time duration of collecting the information, a number of outcomes of the previous pairings, a number of agents involved in the previous pairings, etc. In some embodiments, only if the threshold values are met, the similarity may be determined.

After calculating the similarity scores between the CTs identified by the CT identifiers 614, the similarity score calculator 604 may be configured to send the calculated similarity scores 616 to the clustering module 606. The clustering module 606 may be configured to receive the CT identifiers 614 and the similarity scores 616. After receiving the CT identifiers 614 and the similarity scores 616, the clustering module 606 may be configured to group CTs identified by the CT identifiers 614 into one or more CT clusters based on the similarity scores 616. In some embodiments, in determining whether to group CTs into the same cluster or different clusters, a similarity threshold value may be used. More specifically, the clustering module 606 may be configured to compare a similarity score of two CTs to the similarity threshold value, and determine to group the two CTs into the same CT cluster only if the two CTs' similarity score is greater than or equal to the similarity threshold value. In other examples, where the similarity scores are based on a measurement of dissimilarity, the clustering module 606 may be configured to compare a similarity score of two CTs to the similarity threshold value, and determine to group the two CTs into the same CT cluster only if the two CTs' similarity score is less than or equal to the similarity threshold value.

In one example, if the similarity threshold value is 5, in the Table 1 provided above, only the pairs of (CT #1, CT #2), (CT #2, CT #4), and (CT #3, CT #5) have the similarity scores that are greater than the similarity threshold value. In this example, the CT #1, the CT #2, and the CT #4 are determined to be included in the same cluster, and the CT #3 and the CT #5 are determined to be included in the same cluster. After grouping the CTs into one or more clusters, the clustering module 606 may send to a PS selector 608 CT cluster information 618 indicating the CT clusters.

In some embodiments, the above clustering step may be performed repeatedly. For example, as more contacts of particular CTs are paired with agents, the similarity score between two CTs may be changed. In such case, the clustering of CTs may be performed again based on the updated similarity scores.

In some embodiments, the above clustering step may comprises multiple passes at clustering. For example, if an initial clustering determines a set of clusters, there may then be a determination of a plurality of similarity measurements between each cluster in the set of clusters with remaining clusters in the set of clusters. A subsequent clustering then may be performed based on the plurality of similarity measurements. For example, the subsequent clustering may output fewer clusters than the initial clusters.

In some examples, the clustering module 606 may be configured to determine similarity scores between the CT clusters. The CT cluster information 618 may further include a similarity score or other measurement of similarity between each CT cluster and one or more other CT clusters. Similarity scores for CT clusters may be determined similarly to the similarity scores 616 for CTs, as discussed above.

Upon receiving the CT cluster information 618, the PS selector 608 may be configured to select a PS for each CT cluster and send to the switch 610 PS selection information 620 indicating a selected PS for each CT cluster. In some embodiments, a PS may be selected for each CT cluster based on one or more metrics (e.g., key performance indicators (KPIs) such as revenue, length of contact handling time, customer retention rate, sales, customer service, offer allocation, etc.). In one example, a PS selected for a CT cluster is for maximizing the revenue earned from transactions with the contacts while a PS selected for another CT cluster is for minimizing the length of contact handling time. In some embodiments, the metrics may include business metrics. The business metrics are for defining a company's business goals. Some examples of the metrics are shown below.

Outcome/Metric: The Business Outcome/Metric that should be optimized
for this AI Routing Scope (e.g., First Call Resolution (FCR), Sales,
disconnect rate, handle time, an on-the-call metric, an after-the-call
metric, conversion rate, revenue metrics, service metrics, etc.).
Value: The numeric value for the outcome metric (e.g., dollar value).
Outcome Type: Possible Values are:
Binary: an outcome with two possible values. For example Sale/No Sale.
Continuous: an outcome that theoretically has an infinite number of
values between any two values. Examples include numeric values, dollar
values, etc.
Categorical: an outcome that has a set of distinct, finite values that
may or may not be in logical order. For example, the names of different
packages for a service (basic package, app-only package, web-only
package, etc.) would be considered as categorical data type.

Table 2 provided below shows an example of the content of the PS selection information 620.

TABLE 2

| | |
|---|---|
| CT cluster #1 | FIFO |
| CT cluster #2 | 2D BP |

After receiving the PS selection information 620, the switch 610 may be configured to pair contact(s) with agent(s) using a PS corresponding to the CT cluster of the contact. For example, based on the PS selection information 620 illustrated in Table 2 above, the switch 610 may apply the FIFO PS when pairing contacts having CTs in the CT cluster #1 with agents while applying the BP strategy when pairing contacts having CTs in the CT cluster #2 with agents.

In some embodiments, each CT cluster may operate independently. In those embodiments, changing the PS for one cluster would not change the PS for another cluster. For example, in case the PS selected for the CT cluster #2 is changed from the 2D BP to the 3D BP, a FIFO PS may be continuously used for the CT cluster #1.

In some embodiments, the CT cluster information 618 generated by the CT clustering module 606 may also be sent to the display 622. Examples of the display 622 includes an electro-chromic display, an organic light emitting diode display, a liquid crystal display, etc. Upon receiving the CT cluster information 618, the display 622 may be configured to generate and display a graphical representation of CT clusters indicated by the CT cluster information 618.

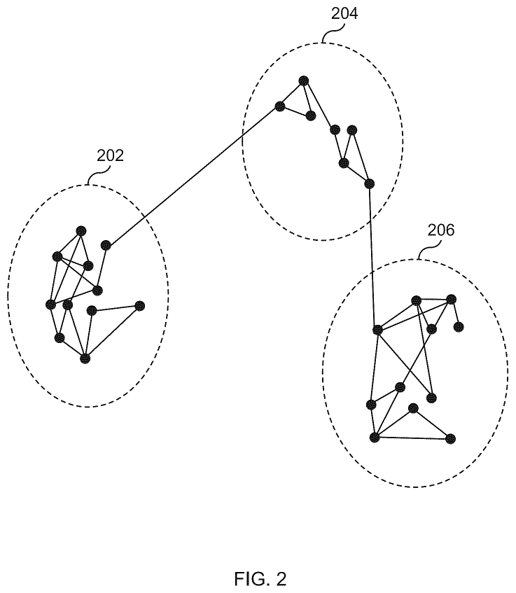

FIG. 2 shows an exemplary graphical representation of a plurality of CT clusters indicated by the CT cluster information 618. In the example shown in FIG. 2, there are three CT clusters—202, 204, and 206. As shown in the figure, each CT cluster includes a plurality of CTs (the black dots). Each CT is connected to one or more different CTs using one or more lines. The length of each of these lines may indicate a degree of similarity between two CTs.

Similarly, as shown in FIG. 2, each CT cluster may be connected to one or more different CT clusters using one or more lines. For example, the CT cluster 202 is connected to the CT cluster 204, and the CT cluster 204 is connected to the CT cluster 206. Like the lines connecting the CTs, each of the line connecting the CT clusters 202 and 204 and the line connecting the CT clusters 204 and 206 may indicate a similarity between two CT clusters.

In other examples, a graphical representation of a plurality of CT clusters indicated by the CT cluster information 618 may visually indicate a degree of similarity between two or more CTs or two or more CT clusters by color mapping, shading, a graphical key, a thickness of the lines between CTs or CT clusters (e.g., a thicker line may mean that the CTs or CT clusters have a higher similarity measurement).

Further, in other embodiments (not shown), one or more CTs or CT clusters may be isolated or disconnected from any other CTs or any other CT clusters. Further, in other embodiments (not shown), one or more CTs or CT clusters may be isolated or disconnected from at least one other set of CTs or at least one other set of CT clusters.

Further, in some embodiments, a second set of historical information and a second set of contact identifiers may be received after a first set of clusters has been determined. Similarity scores may be determined between each of the clusters in the first set of clusters and the second set of contact identifiers based on the second set of historical information. Accordingly, contact types in the second set of contact identifiers may be added to the one of the clusters in the first set of clusters to yield a modified first set of clusters. Alternatively, contact types in the second set of contact identifiers may be grouped as a new cluster and added to the first set of clusters, such that the new clusters receives its own associated PS separate from the PSs corresponding to each cluster in the first set of clusters.

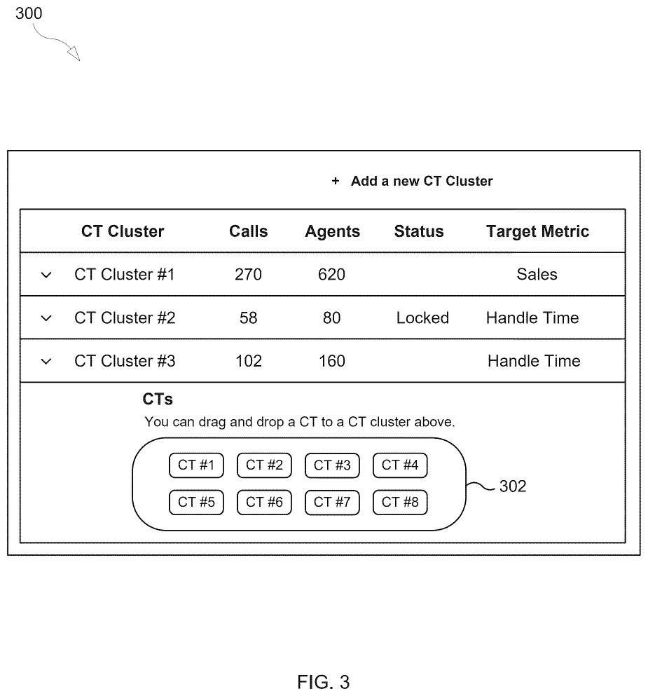

In some embodiments, the display 622 may also be configured to display a graphical user interface (GUI) allowing a user to manually add CT(s) to CT cluster(s) or take out CT(s) from the CT cluster(s). FIG. 3 shows an exemplary GUI 300 for allowing a user to manually add CT(s) to CT cluster(s) or take out CT(s) from the CT cluster(s). For example, the user may move one or more CT(s) from a first CT cluster to a second CT cluster.

As shown in FIG. 3, the GUI 300 shows a list of existing CT clusters (i.e., CT Cluster #1, CT Cluster #2, and CT Cluster #3) and information associated with each CT cluster. For example, the GUI 300 shows a number of calls (i.e., contacts), a number agents corresponding to each of the CT clusters, a target metric associated with each CT cluster, and/or the date that each CT cluster is refreshed/updated. The GUI 300 also provides an option to create a new CT cluster by click the icon “+ Add a new CT cluster.” Additionally, the GUI 300 allows a user to select and draft a CT from a list 302 of CTs and drop the selected CT into a CT cluster such that the CT cluster is modified to include the selected CT.

In some embodiments, the GUI 300 may include a status field indicating a status related to one or more CT clusters. The value of the status field may be determined based on the performance metric of particular CT cluster(s) and/or a user input. In one example, the user may enter in the status field that a particular CT cluster is not available for optimization and/or a particular PS should be used for the particular CT cluster. For example, a value of the status field may be based historical contact-agent interaction data associated with the cluster, including analysis such as: a number of outcomes per month per agent (e.g., this number should be sufficient to allow differentiation in the performance of agents), number of outcomes per day (e.g., this number should be sufficient to measure and compare performance of multiple pairing strategies), number of concurrent agents (e.g., number of agents who are concurrently logged into the contact center, and this number should be sufficient to provide sufficient choice), and estimated agent choice (e.g., a count of choice at moments when contact-agent pairings were determined).

More specifically, in some embodiments, whether a particular PS is suitable for pairing contacts in a particular CT cluster may be determined based on the analysis of one or more of the above listed variables. In one example, pairing contacts in a particular CT cluster using a particular PS is appropriate only when the number of the outcomes (per month per agent and/or per day) is greater than a threshold value, when the number of the concurrent agents is greater than a threshold value, and when the number of agents available for pairing is greater than a threshold value.

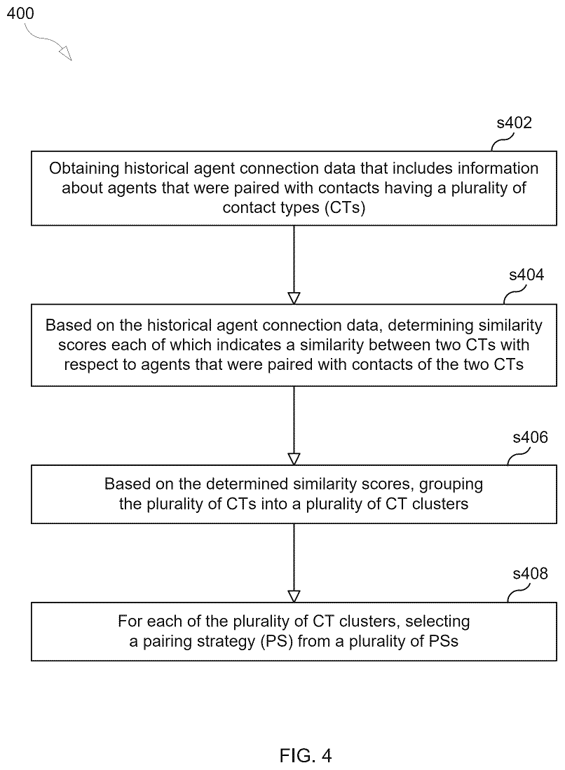

FIG. 4 shows a process 400 according to some embodiments. The process 400 may begin with step s402. The step s402 comprises obtaining historical agent connection data that includes information about agents that were paired with contacts having a plurality of contact types (CTs). Step s404 comprises, based on the historical agent connection data, determining similarity scores each of which indicates a similarity between two CTs with respect to agents that were paired with contacts of the two CTs. Step s406 comprises, based on the determined similarity scores, grouping the plurality of CTs into a plurality of CT clusters, wherein each CT cluster includes one or more CTs. Step s408 comprises, for each of the plurality of CT clusters, selecting a pairing strategy (PS) from a plurality of PSs.

In some embodiments, the historical agent connection data indicates: a first contact group of one or more contacts, a second contact group of one or more contacts, a first agent group of one or more agents paired with the first contact group, and a second agent group of one or more agents paired with the second contact group, the first contact group includes contacts of a first CT, and the second contact group includes contacts of a second CT.

In some embodiments, the similarity scores include a first similarity score indicating a similarity between the first CT and the second CT, and the similarity between the first CT and the second CT is determined based on a similarity between the first agent group and the second agent group.

In some embodiments, the similarity between the first agent group and the second agent group is determined based on a number of agents that belong to both the first agent group and the second agent group.

In some embodiments, the information about agents that were paired with contacts having the plurality of CTs comprises one or more of the following parameters: (i) a routing treatment, (ii) a log-in event, (iii) a log-out event, (iv) agent attributes, (v) agent skills, and/or (vi) agent eligibility.

In some embodiments, the similarity between the first agent group and the second agent group is determined based on a similarity between one or more of the parameters (i)-(vi) associated with the first agent group and one or more of the paragraphs (i)-(vi) associated with the second agent group.

In some embodiments, each of the similarity scores is provided in the form of an adjacency matrix, a node graph, and/or an edge graph.

In some embodiments, the process comprises displaying the plurality of CT clusters on a display screen.

In some embodiments, the process comprises: obtaining a contact identifier identifying a contact that is available for pairing; determining a CT of the contact; identifying a CT cluster corresponding to the determined CT; determining a PS corresponding to the identified CT cluster; obtaining a plurality of agent identifiers identifying a plurality of agents that are available for pairing; using the PS, selecting from the plurality of agents an agent to be paired with the contact.

In some embodiments, the process comprises obtaining updated historical agent connection data that includes updated information about agents that were paired with contacts having the CTs; based on the updated historical agent connection data, determining similarity scores each of which indicates a similarity between two CT clusters with respect to agents that were paired with contacts of the two CT clusters; based on the updated similarity scores, grouping the plurality of CT clusters into one or more of updated CT clusters; and for each of said one or more updated CT clusters, selecting a PS from the plurality of PSs.

In some embodiments, a PS is selected from the plurality of PS for each of the plurality of CT clusters based on one or more metrics.

In some embodiments, said one or more metrics are key performance indicators (KPIs), and the selected PS is for maximizing said one or more KPIs for each of the plurality of CT clusters.

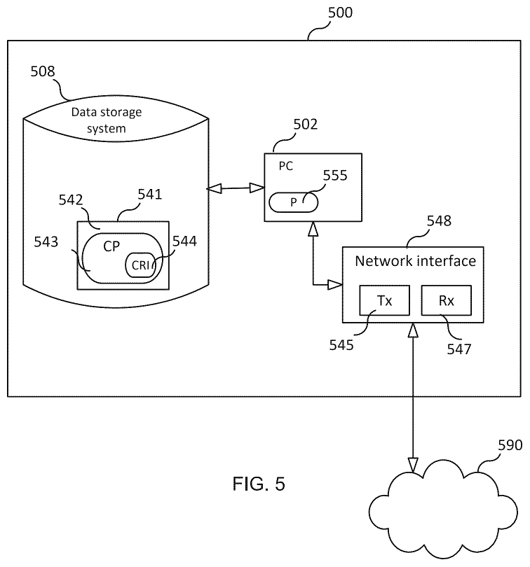

FIG. 5 is a block diagram of an apparatus 500, according to some embodiments. Any one or a combination of the data collector 602, the similarity score calculator 604, the clustering module 606, the pairing strategy (PS) selector 608, the switch 610, and the display 622 may be implemented in the form of the apparatus 500. As shown in FIG. 5, apparatus 500 may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 500 may be a distributed computing apparatus); a network interface 548 comprising a transmitter (Tx) 545 and a receiver (Rx) 547 for enabling apparatus 500 to transmit data to and receive data from other nodes connected to a network 590 (e.g., an Internet Protocol (IP) network) to which network interface 548 is connected (directly or indirectly) (e.g., network interface 548 may be wirelessly connected to the network 590, in which case network interface 548 is connected to an antenna arrangement); and a local storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes apparatus 500 to perform steps described herein (e.g., steps described herein with reference to the flow charts). In other embodiments, apparatus 500 may be configured to perform steps described herein without the need for code. That is, for example, PC 502 may consist merely of one or more ASICs. Hence, the features of the embodiments described herein may be implemented in hardware and/or software.

Note that FIG. 6 is merely a conceptual diagram of the apparatus according to the embodiments of this disclosure. It may not show real physical aspects the apparatus. In other words, the physical characteristics of the apparatus shown in FIG. 6 do not limit the embodiments of this disclosure in any way. For example, in some embodiments, any two or more of the elements 602, 604, 606, 608, 610, and 622 may be included in a single entity (e.g., a processor).

### Summary of Various Embodiments

A1. A method 400 comprising: obtaining s402 historical agent connection data that includes information about agents that were paired with contacts having a plurality of contact types (CTs): based on the historical agent connection data, determining s404 similarity scores each of which indicates a similarity between two CTs with respect to agents that were paired with contacts of the two CTs: based on the determined similarity scores, grouping s406 the plurality of CTs into a plurality of CT clusters, wherein each CT cluster includes one or more CTs; and for each of the plurality of CT clusters, selecting s408 a pairing strategy (PS) from a plurality of PSs.
A2. The method of embodiment A1, wherein the historical agent connection data indicates: a first contact group of one or more contacts, a second contact group of one or more contacts, a first agent group of one or more agents paired with the first contact group, and a second agent group of one or more agents paired with the second contact group, the first contact group includes contacts of a first CT, and the second contact group includes contacts of a second CT.
A3. The method of embodiment A2, wherein the similarity scores include a first similarity score indicating a similarity between the first CT and the second CT, and the similarity between the first CT and the second CT is determined based on a similarity between the first agent group and the second agent group.
A4. The method of embodiment A3, wherein the similarity between the first agent group and the second agent group is determined based on a number of agents that belong to both the first agent group and the second agent group.
A5. The method of at least one of embodiments A1-A4, wherein the information about agents that were paired with contacts having the plurality of CTs comprises one or more of the following parameters: (i) a routing treatment, (ii) a log-in event, (iii) a log-out event, (iv) agent attributes, (v) agent skills, and/or (vi) agent eligibility.
A6. The method of embodiment A5 (when embodiment A5 depends on embodiment A3), wherein the similarity between the first agent group and the second agent group is determined based on a similarity between one or more of the parameters (i)-(vi) associated with the first agent group and one or more of the paragraphs (i)-(vi) associated with the second agent group.
A7. The method of at least one of embodiments A1-A6, wherein each of the similarity scores is provided in the form of an adjacency matrix, a node graph, and/or an edge graph.
A8. The method of at least one of embodiments A1-A7, comprising displaying the plurality of CT clusters on a display screen.
A9. The method of at least one of embodiments A1-A8, comprising: obtaining a contact identifier identifying a contact that is available for pairing: determining a CT of the contact: identifying a CT cluster corresponding to the determined CT: determining a PS corresponding to the identified CT cluster: obtaining a plurality of agent identifiers identifying a plurality of agents that are available for pairing: using the PS, selecting from the plurality of agents an agent to be paired with the contact.
A10. The method of at least one of embodiments A1-A9, comprising: obtaining updated historical agent connection data that includes updated information about agents that were paired with contacts having the CTs: based on the updated historical agent connection data, determining similarity scores each of which indicates a similarity between two CT clusters with respect to agents that were paired with contacts of the two CT clusters: based on the updated similarity scores, grouping the plurality of CT clusters into one or more of updated CT clusters; and for each of said one or more updated CT clusters, selecting a PS from the plurality of PSs.
A11. The method of at least one of embodiments A1-A10, wherein a PS is selected from the plurality of PS for each of the plurality of CT clusters based on one or more metrics.
A12. The method of embodiment A11, wherein said one or more metrics are key performance indicators (KPIs), and the selected PS is for maximizing said one or more KPIs for each of the plurality of CT clusters.
B1. A computer program comprising instructions which when executed by processing circuitry cause the processing circuitry to perform the method of at least one of embodiments A1-A12.
B2. A carrier containing the computer program of embodiment B1, wherein the carrier is one of an electronic signal, an optical signal, a radio signal, and a computer readable storage medium.
C1. An apparatus 500 being configured to: obtain 402 historical agent connection data that includes information about agents that were paired with contacts having a plurality of contact types (CTs); based on the historical agent connection data, determine 404 similarity scores each of which indicates a similarity between two CTs with respect to agents that were paired with contacts of the two CTs: based on the determined similarity scores, group 406 the plurality of CTs into a plurality of CT clusters, wherein each CT cluster includes one or more CTs; and for each of the plurality of CT clusters, select 408 a pairing strategy (PS) from a plurality of PSs.
C2. The apparatus of embodiment C1, wherein the apparatus is further configured to perform the method of at least one of embodiments A2-A12.
D1. An apparatus 500, the apparatus comprising: a memory 542; and processing circuitry 502 coupled to the memory, wherein the apparatus is configured to perform the method of at least one of embodiments A1-A12.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method comprising:
obtaining historical agent connection data that includes information about agents that were paired with contacts having a plurality of contact types (CTs);
based on the historical agent connection data, determining similarity scores each of which indicates a similarity between two CTs with respect to agents that were paired with contacts of the two CTs;
based on the determined similarity scores, grouping the plurality of CTs into a plurality of CT clusters, wherein each CT cluster includes one or more CTs; and
for each of the plurality of CT clusters, selecting a pairing strategy (PS) from a plurality of pairing strategies (PSs).

2. The method of claim 1, wherein
the historical agent connection data indicates:
a first contact group of one or more contacts,
a second contact group of one or more contacts,
a first agent group of one or more agents paired with the first contact group, and
a second agent group of one or more agents paired with the second contact group,
the first contact group includes contacts of a first CT, and
the second contact group includes contacts of a second CT.

3. The method of claim 2, wherein
the similarity scores include a first similarity score indicating a similarity between the first CT and the second CT, and
the similarity between the first CT and the second CT is determined based on a similarity between the first agent group and the second agent group.

4. The method of claim 3, wherein
the similarity between the first agent group and the second agent group is determined based on a number of agents that belong to both the first agent group and the second agent group.

5. The method of claim 1, wherein
the information about agents that were paired with contacts having the plurality of CTs comprises one or more of the following parameters:
(i) a routing treatment,
(ii) a log-in event,
(iii) a log-out event,
(iv) agent attributes,
(v) agent skills, and/or
(vi) agent eligibility.

6. The method of claim 5, wherein
the historical agent connection data indicates:
a first contact group of one or more contacts,
a second contact group of one or more contacts,
a first agent group of one or more agents paired with the first contact group, and
a second agent group of one or more agents paired with the second contact group,
the first contact group includes contacts of a first CT,
the second contact group includes contacts of a second CT,
the similarity scores include a first similarity score indicating a similarity between the first CT and the second CT,
the similarity between the first CT and the second CT is determined based on a similarity between the first agent group and the second agent group, and
the similarity between the first agent group and the second agent group is determined based on a similarity between one or more of the parameters (i)-(vi) associated with the first agent group and one or more of the paragraphs (i)-(vi) associated with the second agent group.

7. The method of claim 1, wherein
each of the similarity scores is provided in the form of an adjacency matrix, a node graph, and/or an edge graph.

8. The method of claim 1, wherein
the method further comprises displaying the plurality of CT clusters on a display screen.

9. The method of claim 1, wherein
the method further comprises:
obtaining a contact identifier identifying a contact that is available for pairing;
determining a CT of the contact;
identifying a CT cluster corresponding to the determined CT;
determining a PS corresponding to the identified CT cluster;
obtaining a plurality of agent identifiers identifying a plurality of agents that are available for pairing; and
using the PS, selecting from the plurality of agents an agent to be paired with the contact.

10. The method of claim 1, wherein
the method further comprises
obtaining updated historical agent connection data that includes updated information about agents that were paired with contacts having the CTs;
based on the updated historical agent connection data, determining similarity scores each of which indicates a similarity between two CT clusters with respect to agents that were paired with contacts of the two CT clusters;
based on the updated similarity scores, grouping the plurality of CT clusters into one or more of updated CT clusters; and
for each of said one or more updated CT clusters, selecting a PS from the plurality of PSs.

11. The method of claim 1, wherein
a PS is selected from the plurality of PS for each of the plurality of CT clusters based on one or more metrics.

12. The method of claim 11, wherein
said one or more metrics are key performance indicators (KPIs), and
the selected PS is for maximizing said one or more KPIs for each of the plurality of CT clusters.

13. A non-transitory computer readable storage medium storing instructions for configuring an apparatus comprising processing circuitry operable to execute the instructions to perform the method of claim 1.

14. An apparatus, the apparatus comprising:
a memory; and
processing circuitry coupled to the memory, wherein the apparatus is configured to perform a method comprising:
obtaining historical agent connection data that includes information about agents that were paired with contacts having a plurality of contact types (CTs);
based on the historical agent connection data, determining similarity scores each of which indicates a similarity between two CTs with respect to agents that were paired with contacts of the two CTs;
based on the determined similarity scores, grouping the plurality of CTs into a plurality of CT clusters, wherein each CT cluster includes one or more CTs; and
for each of the plurality of CT clusters, selecting a pairing strategy (PS) from a plurality of pairing strategies (PSs).

15. The apparatus of claim 14, wherein
the historical agent connection data indicates:
a first contact group of one or more contacts,
a second contact group of one or more contacts,
a first agent group of one or more agents paired with the first contact group, and
a second agent group of one or more agents paired with the second contact group,
the first contact group includes contacts of a first CT, and
the second contact group includes contacts of a second CT.

16. The apparatus of claim 15, wherein
the similarity scores include a first similarity score indicating a similarity between the first CT and the second CT, and
the similarity between the first CT and the second CT is determined based on a similarity between the first agent group and the second agent group.

17. The apparatus of claim 16, wherein
the similarity between the first agent group and the second agent group is determined based on a number of agents that belong to both the first agent group and the second agent group.

18. The apparatus of claim 14, wherein
the information about agents that were paired with contacts having the plurality of CTs comprises one or more of the following parameters:
(i) a routing treatment,
(ii) a log-in event,
(iii) a log-out event,
(iv) agent attributes,
(v) agent skills, and/or
(vi) agent eligibility.

19. The apparatus of claim 18, wherein
the historical agent connection data indicates:
a first contact group of one or more contacts,
a second contact group of one or more contacts,
a first agent group of one or more agents paired with the first contact group, and
a second agent group of one or more agents paired with the second contact group,
the first contact group includes contacts of a first CT, and
the second contact group includes contacts of a second CT,
the similarity scores include a first similarity score indicating a similarity between the first CT and the second CT,
the similarity between the first CT and the second CT is determined based on a similarity between the first agent group and the second agent group, and
the similarity between the first agent group and the second agent group is determined based on a similarity between one or more of the parameters (i)-(vi) associated with the first agent group and one or more of the paragraphs (i)-(vi) associated with the second agent group.

20. The apparatus of claim 14, wherein
each of the similarity scores is provided in the form of an adjacency matrix, a node graph, and/or an edge graph.
